(19) United States
(12) Patent Application Publication
(10) Pub. No.: US 2006/0255020 A1
(43) Pub. Date: Nov. 16, 2006

(54) Method for production of laser-induced images inside liquids

(76) Inventor: Igor Troitski, Henderson, NV (US)

Correspondence Address: IGOR TROITSKI, 853 ARROWHEAD TRAIL, HENDERSON, NV, 89015, US

(21) Appl. No.: 11/129,730

(22) Filed: May 16, 2005

(51) Int. Cl. B23K 26/00

(52) U.S. Cl. 219/121.69

(57) ABSTRACT

One or more embodiments of the invention comprise a method for production of laser-induced images inside liquids. These images are arrangement of sparks or bubbles, or their combination, which created by the laser-induced breakdowns at the predetermining liquid areas. A method for production of high resolution laser-induced images inside liquids by the generation of the breakdowns accompanying with the decreasing shock waves is disclosed. Another embodiment of the invention comprises a method for production of the motion laser-induced images inside liquid. These images are the successions of the small light sources arrangements which replace one another in accordance with the life time of these sources (bubbles or sparks) and in accordance with human eye inertia.

### FIELD OF THE INVENTION

The present invention relates to methods for producing laser-induced images inside transparent medium, particularly, inside transparent liquid by using pulsed laser radiation.

### BACKGROUND OF THE INVENTION

A number of techniques for creation of images inside solid transparent substrates by using pulsed laser radiation are well known.

The publication disclosing such techniques is the Russian invention # 321422 to Agadjanov et. al., published on Nov. 16, 1970 (#140454529-33). The invention concerns a method of manufacturing decorative products inside a transparent material by changing the material structure by laser radiation. As disclosed, by moving a material relative to a focused laser beam, it is possible to create a drawing inside the material.

U.S. Pat. No. 4,092,518 to Merard discloses a method for decorating transparent plastic articles. This technique is carried out by directing a pulsed laser beam into the body of an article by successively focusing the laser beam in different regions within the body of the article. The pulse energy and duration is selected based upon the desired extent of the resulting decorative pattern. The effect of the laser is a number of three dimensional “macro-destruction” (fissures in the material of the article) appearing as fanned-out cracks. The pattern of the cracks produced in the article is controlled by changing the depth of the laser beam focus along the length of the article. Preferably, the article is in the form of a cylinder, and the cracks are shaped predominantly as saucer-like formations of different size arranged randomly around the focal point of the optical system guiding a laser beam. The device used to carry out this technique is preferably a multi-mode solid-state, free-running pulse laser used in conjunction with a convergent lens having a focal length from 100 to 200 mm.

U.S. Pat. No. 4,843,207 to Urbanek et al. discloses a method of creating controlled decorations on the surface of a hollow symmetrical transparent article. This technique is preferably carried out on glass. The glass is preconditioned with a coating on the outer surface of the glass being approximately 1.2 mm thick and made of a material having at least 75% absorption of laser radiation. The technique is also carried out using a laser having a wave of length of 0.5 to 2 microns acting upon the external coating through the wall of the cylindrical glass article. The laser beam moves so that it is focused on the surface of the cylinder, and moves about the axis of symmetry of the cylinder to irradiate the aforementioned surface coating. As a result, the irradiated portions of the surface coating go through a phase change and a pattern is formed.

U.S. Pat. No. 5,206,496 to Clement et al. discloses a method and apparatus for providing in a transparent material, such as glass or plastic, a mark which is visible to the naked eye or which may be “seen” by optical instruments operating at an appropriate wavelength. The Clement et al. Patent describes a method and apparatus for producing a subsurface marking which is produced in a body such as bottle, by directing into the body a high energy density beam and bringing the beam to focus at a location spaced from the surface, so as to cause localized ionization of the material. In the preferred embodiment the apparatus includes a laser as the high energy density beam source. The laser may be a Nd-YAG laser that emits a pulsed beam of laser radiation with a wavelength of 1064 nra. The pulsed beam is incident upon a first mirror that directs the beam through a beam expander and a beam combiner to a second mirror. A second source of laser radiation in the form of a low power He—Ne laser emits a secondary beam of visible laser radiation with a wavelength of 638 m. The secondary beam impinges upon the beam combiner where it is reflected toward the second reflecting surface coincident with the pulsed beam of laser radiation from the Nd-YAG laser. The combined coincident beams are reflected at the reflecting surface via reflecting two other surfaces to a pair of movable mirrors for controlling movement of the beam. The beam then passes through a lens assembly into the body to be marked.

U.S. Pat. No. 5,575,936 to Goldfarb discloses a process and apparatus where a focused laser beam causes local destruction within a solid article, without affecting the surface thereof. The apparatus for etching an image within a solid article includes a laser focused to a focal point within the article. The position of the article with respect to the focal point is varied. Control means, coupled to the laser, and positioning means are provided for firing the laser so that a local disruption occurs within the article to form the image within the article.

U.S. Pat. No. 5,637,244 to Erokhin discloses a technique which depends on a particular optical system including a diffraction limited Q-switched laser (preferably a solid-state single-mode TEM aimed into a defocusing lens having a variable focal length to control the light impinging on a subsequent focusing lens that refocuses the laser beam onto the transparent article being etched. The laser power level, operation of the defocusing lens, and the movement of the transparent article being etched are all controlled by a computer. The computer operates to reproduce a pre-programmed three-dimensional image inside the transparent article being etched. In the computer memory, the image is presented as arrays of picture elements on various parallel planes. The optical system is controlled to reproduce the stored arrays of picture elements inside the transparent material. A method for forming a predetermined half-tone image is disclosed. Accordance to the method, micro-destructions of a first size are created to form a first portion of the image and micro-destruction of a second size different from the first size are created to form a second portion of the image. Different sizes of micro-destructions are created by changing the laser beam focusing sharpness and the radiation power thereof before each shot.

U.S. Pat. No. 5,656,186 to Mourou, et al. discloses method for laser induced breakdown of a material with a pulsed laser beam where the material is characterized by a relationship of breakdown threshold versus laser beam pulse width that exhibits an abrupt, rapid and distinct change or at least a clearly detectable and distinct change in slope at a predetermined laser pulse width value.

U.S. Pat. No. 5,886,318 to A. Vasiliev and B. Goldfarb discloses a method for laser-assisted image formation in transparent specimens which consists in establishing a laser beam having different angular divergence values in two mutually square planes. An angle between the plane with a maximum laser beam angular divergence and the surface of the image portion being formed is changed to suit the required contrast of an image.

U.S. Pat. No. 6,087,617 to Troitski et al. discloses a computer graphic system for producing an image inside optically transparent material. An image reproducible inside optically transparent material by the system is defined by potential etch points, in which the breakdowns required to create the image in the selected optically transparent material are possible. The potential etch points are generated based on the characteristics of the selected optically transparent material. If the number of the potential etch points exceeds a predetermined number, the system carries out an optimization routine that allows the number of the generated etch points to be reduced based on their size. To prevent the distortion of the reproduced image due to the refraction of the optically transparent material, the coordinates of the generated etch points are adjusted to correct their positions along a selected laser beam direction.

U.S. Pat. No. 6,333,485 to Haight, Ct al. discloses method for minimizing sample damage during the ablation of material using a focused ultra short pulsed beam. In one aspect the invention provides a method for laser induced breakdown of a material with a pulsed laser beam where the material is characterized by a relationship of flounce breakdown threshold versus laser beam pulse width that exhibits an abrupt, rapid, and distinct change or at least a clearly detectable and distinct change in slope at a predetermined laser pulse width value.

U.S. Pat. No. 6,333,486 to Troitski discloses a method for production of etch points inside transparent material, which have the same size but different brightness. Laser-induced damages produced by this method provide the reproduction of image gradation without changing of their spatial resolution.

U.S. Pat. No. 6,399,914 to Troitski discloses a method for producing laser-induced images inside the special transparent material containing special kinds of impurities, which decrease the damage threshold of the material that provides creation of small and without star structure laser-induced damages.

U.S. Pat. No. 6,417,485 to Troitski discloses a method and laser system for producing laser-induced damages inside transparent materials by controlling breakdown process development. At the beginning an applied laser radiation level just exceeds an energy threshold for creating a plasma condition inside the transparent material, and thereafter the energy level of the applied laser radiation is just maintain the plasma condition and is applied before the plasma condition extinguished, but after a shock wave associated therewith has passed.

U.S. Pat. No. 6,426,480 to Troitski discloses a method and system for producing single layer laser-induced damage portrait inside transparent material which are based on generation of small smoothed etch points of determined sizes and on control of their brightness without variation of their determined sizes.

U.S. Pat. No. 6,490,299 to Raevski et a!. discloses method and laser system producing high quality laser-induced images inside transparent materials by using specific laser radiation generated by serial combination of both generation regimes: a Q switched mode and a free-running mode.

U.S. Pat. No. 6,509,548 to Troitski discloses a method and apparatus for producing high-resolution laser-induced damage images inside transparent materials by small etch points. The method is based on generation of the initial electron density in the relatively large volum, creation of the breakdown at a small part of the said volume and control of the energy amount enclosed inside the plasma.

U.S. Pat. No. 6,596,967 to Miesak discloses a laser based etching device, which modifies the optical properties of an object by using a light beam from a light source that is focused at a first focal point within the object to optically change a first location within the object at the first focal point.

U.S. Pat. No. 6,605,797 to Troitski discloses laser-computer graphics systems for producing images such as portraits and 3-1) sculptures formed from laser light created etch points inside an optically transparent material. The produced image has a high resolution like a computer graphic image from which it is derived, little fluctuation in gray shades, and has no discernible point structure.

U.S. Pat. No. 6,630,644 to Troitski et al. discloses a method for creating arrangement of damages for producing 3D laser-induced damage portraits with the space resolution, which is equal to the appropriate computer 3D model.

U.S. Pat. No. 6,664,501 to Troitski discloses a method for creating laser-induced color images within three-dimensional transparent material.

U.S. Pat. No. 6,670,576 to Troitski et al. discloses a method for producing laser-induced images inside transparent materials containing laser-induced color centers and laser-induced damages.

U.S. Pat. No. 6,720,521 to Troitski discloses a method for generating an area of laser-induced damage inside a transparent material by controlling a special structure of a laser radiation.

U.S. Pat. No. 6,720,523 to Troitski discloses a method for production of laser induced images inside transparent material, when complete image information is lacking before production and is supplemented only during production.

U.S. Pat. No. 6,727,460 to Troitski discloses a system for high-speed production of high quality laser-induced damage images inside transparent materials. The system produces the said images by the combination of an electro-optical deflector and means for moving the article or focusing optical system.

U.S. Pat. No. 6,734,389 to Troitski discloses an apparatus for producing high quality laser-induced images inside optically transparent material by controlling breakdown process development and space structure of laser radiation.

U.S. Pat. No. 6,740,846 to Troitski et al. discloses a method for producing 3D laser-induced portrait by using several 2D regular portraits.

U.S. Pat. No. 6,768,080 to Troitski discloses a method for production of laser-induced images which are looked like iridescent images laying out white light incident upon them. These images are created by generation of laser-induced damages of special space form.

U.S. Pat. No. 6,768,081 to Troitski discloses a method and apparatus for producing high quality laser-induced images inside optically transparent material by using material processing made before and after image creation.

All patents mentioned above disclose methods and systems for creation of laser-induced images inside solid transparent materials. Most of these methods and systems are based on the breakdown phenomena, which is produced by focusing laser beam inside solid transparent material. The laser-induced breakdown creates a small damage of the transparent material which is visible because it scatters the exterior light. Thus, laser-induced images (more correctly, laser-induced damage images) produced by the systems disclosed in patents mentioned above are the pluralities of the damages inside a solid transparent material created by a pulsed laser beam, which is periodically focused at predetermined points of the material. These laser-induced damage images are stationary in time; they are created for ever and can be destroyed by destruction of the transparent material only.

However analogously to solid transparent materials, laser-induced damages can be created inside transparent liquids. These damages are bubbles created as a result of breakdown and unlike the damages inside solid transparent material they are not stationary in time and live during a period depending on the liquid property. The bubbles are visible because they scatter the exterior light. The first purpose of the invention is the disclosure of a method and a system for creation of laser-induced images inside liquids by using bubbles created by the laser-induced breakdowns.

Besides the bubbles, the breakdowns, simultaneously, create bright flashes of white light (sparks). The breakdown sparks exist during very short time period but they can have very high brightness and therefore are visible with the naked eye. Unlike the bubbles, which are visible because they scatter the exterior light, the sparks are visible because they irradiate light. Obviously using the sparks it is also possible to create instantaneous images inside liquids. The second purpose of the invention is to disclose a method for creation of such instantaneous images inside liquids containing sparks created by laser-induced breakdowns generated at the predetermining points of the liquid medium.

### SUMMARY OF THE INVENTION

The principal task of the present invention is to provide a method for production of laser-induced images inside liquids. These images are arrangements of sparks, bubbles or combinations of sparks and bubbles created by the laser radiation at the predetermining points of the liquids. These sparks and bubbles are generated by laser-induced breakdowns.

One or more embodiments of the invention comprise a method for generation of breakdown bubbles and sparks of the predetermined parameters needed for production of high quality laser-induced images inside liquids. The method provides creation of breakdowns with weak shock waves. The diminution of the shock wave permits to decrease the minimal distance between adjacent breakdowns that gives a chance to create laser-induced images of high space resolution.

Another embodiment of the invention comprises a method for production of a motion laser-induced image inside liquid. This image is a succession of small light sources arrangements created inside liquid. Each such arrangement contains small light sources (sparks, bubbles or their combination), which live short time and after the previous arrangement is replaced by the following arrangement. The period between adjacent arrangements is determined by the life time of the small light sources and the eye inertia.

Another embodiment of the invention comprises a method for production of the latent laser-induced images by generation of physical-chemical changes of the liquid.

### DESCRIPTION OF THE DRAWINGS

FIG. 1 shows a photo of a breakdown spark produced inside water by Nd:YAG laser radiation focused by lens with short focal length (35 mm).

FIG. 2 illustrates a simple laser-induced image corresponding to an elementary arrangement of the breakdown sparks produced inside water.

### DETAILED DESCRIPTION OF THE INVENTION

The invention comprises a method for production of laser-induced images inside liquids by using sparks, bubbles or their combination generated by the laser-induced breakdowns.

The liquid state, occupying an intermediate position between gases and solids and combines some features of both of these states, therefore the laser-induced breakdown inside liquid combines some features of these phenomena which accompany the breakdown inside both solids and gases. Laser-induced plasma formation and cavitations in a liquid were observed by P. A. Barnes and K. E. Rieckhoff in 1968 (John F. Ready, Effects of High-Power Laser Radiation, Academic Press, 1971, New York, page 304). They showed that the breakdown and the pressure pulses can be produced in transparent liquids at lower light intensities than in solids and that these phenomena are apparently related to the same mechanisms that produce damage in solids. Simultaneous plasma formation was indicated by a stream of small bubbles in the water and emission of intense white light. The initial plasma leads to production of a shock wave. Measurements of the emission from the spark indicated a blackbody like spectrum with a temperature of 15000° K. High-amplitude acoustic waves are generated in conjunction with breakdown. The acoustic waves produced in the focal region propagate in the same direction as the incident laser beam. The acoustic transient contains wide-band pressure impulses with frequency components up to 2400 MHz. The breakdown is accompanied by white sparks near the focal region and sometimes by ejection of liquid above the top surface of the sample. It was estimated that the laser-induced impulses approximately 3 mm from the region of the breakdown had peak pressure of the order of 5×108 dyn cm. It was concluded that dissolved gases played a role in the production of the dielectric breakdown. When distilled filtered water was used, the number of shocks was considerably reduced. This was interpreted as supporting the idea that the shocks are generated by excitation of impurities present in the water rather than by direct absorption by the water molecules.

Consequently, breakdowns generated inside liquids produce two kinds of small light sources: the cavitations (bubbles), which are visible due to scattering external light, and sparks, which are visible due to irradiation of board spectrum light. Obviously, that both these small light sources can be used for creation of 3D and 2D images inside liquids. The quality of the images depends on the space resolution of the images and the number of grade shades (half tones) reproduced by the images which are provided by the arrangements of sparks and bubbles. It is also very important to notice that the life time of these small light sources is limited: life time of bubbles is restricted by liquid fluidity; life time of sparks is restricted by time of plasma existing. Comparing this situation with breakdowns inside solids and gases, we can see that breakdowns inside solids create sparks and damages of the transparent materials, which are also visible due to scattering external light, but these damages are stationary in time. Breakdowns inside gases create sparks only. Usually, breakdown threshold in liquids is lower than inside transparent solids and gases that provides the better control of sparks sizes and brightness. Breakdown bubbles have smoothing shapes without “cracks” accompanying breakdown damages. Of course, the use of such smooth bubbles gives a chance to create laser-induced images inside liquids of higher quality than inside solids. However, creation of laser-induced images inside liquids has its specific problems: the first, the breakdown generates a shock wave which destroys the neighboring bubbles; the second, bubbles have limited life time. The first problem can be decided by using special laser radiation which is able to create breakdowns without strong shock waves; the second problem is decided by using transparent liquids with low coefficient of fluidity.

One or more embodiments of the invention comprise a method for creation of small light sources inside liquid by generating the laser-induced breakdowns at the corresponding local liquid areas. These light sources are two different kinds: the first kind is sparks which are visible due to the irradiation of the board spectrum light; the second kind is the bubbles, which are visible by scattering external light. Generation of the breakdowns at the local areas demands creation of laser radiation, energy of which increases the breakdown threshold at these areas only. It can be produced by two ways: the first—the laser radiation is focused at the corresponding areas; the second—several laser beams intersect at the desirable areas. If energy of each beam is below the breakdown threshold and their total energy increases the breakdown threshold, then breakdowns is generated at the desirable areas only.

Creation of small light sources inside predetermined liquid areas gives a chance to create laser-induced images inside liquids. In accordance with the two kinds of light sources, it is possible to create two kinds of laser-induced images inside liquid. The first kind of the laser-induced images is the images which are an arrangement of the sparks (spark images). The second kind of the laser-induced images is the images, which are an arrangement of the bubbles (bubble images). The life time of the babble images is longer then the spark images.

Creation of a half toned image which reproduces gray shades is possible by modulation of the brightness of the small light sources contained in the image. Brightness of a bubble is proportional to its size. Control of sizes and brightness of the breakdown sparks and bubbles inside liquids is produced by changing pulse energy of used laser radiation but so that the value of the pulse energy is always higher than threshold energy. Corresponding minimal pulse energy generates sparks and bubbles with minimal brightness and sizes. The increase of the pulse energy provides generation of light sources inside liquid with larger sizes and higher brightness.

Another method for controlling sizes and brightness of the breakdown sparks and bubbles inside liquids is the variation of pulse duration. Decrease of the pulse duration provides the creation of smaller sparks and bubbles inside liquids.

The small breakdown sparks can be created in liquids which have low breakdown threshold. Usually, the breakdown threshold of liquid is decreased if the liquid is under increased pressure. Therefore, it is possible to create laser-induced images containing small light sources inside liquids by using reserved vessel in which liquid is under increased pressure.

In case of the creation of the laser-induced images inside solid transparent material, generation of small laser-induced damages is sufficient condition for production of high resolution images. In case of the creation of the laser-induced images inside liquids, the generation of the small sparks and bubbles is the requirement, but not the sufficient condition, and for the production of high resolution images inside liquids it is also necessary to produce the breakdowns accompanying by weak shock waves. In common both these conditions determine the minimal distance between adjacent breakdowns so that the production of new light source does not disturb the adjacent light sources, which have been already generated. In particular, the distances between adjacent breakdowns are not smaller the minimal distance so that the shock waves of the breakdowns generating the new sparks and bubbles do not destroy adjacent sparks and bubbles which have been already created.

One of the methods which permit to decrease the breakdown shock waves is based on the diminution of the pulse duration. Using laser radiation with ultra short pulses provides the creation of neighbor bubbles at a short distance inside liquid, because a shock wave accompanying creation of new bubble does not destroy adjacent bubble.

Another method for the decrease of breakdown shock waves is based on the use of the special kind of laser radiation. This radiation should create hot plasma at the focal area for very short time and after it should maintain the plasma condition. In this case, the pulse energy increases the breakdown threshold during only the short period and after can be smaller. As a result, the integral power of shock wave is decreased.

Another embodiment of the invention comprises a method for decreasing the destruction action of breakdown shock waves by simultaneous creation of several breakdowns centers so that their shocks waves extinguish each other. Generation of breakdowns at several liquid points simultaneously can be produced by special space structure of laser radiation or by using the special beam focusing optics which focuses the beam at several near points.

It is also possible to decrease the shock waves and produce the small sparks and small bubbles by focusing laser radiation at the minimal focal area. This can be provided by using single mode laser radiation or using laser radiation of short wave length.

The diminution of the breakdown shock waves is also provided by decreasing breakdown threshold of the used transparent liquids. This can be achieved by controlling properties of the liquids. For one kind of liquid it is desirable that they are very pure liquid. For another kind of liquid, the breakdown threshold can be reduced by dissolving in the used liquid the very small impurities which do not practically change transparent characteristics of the liquid but which decrease breakdown threshold considerably. The use of special kinds of impurities gives a chance to change the spark spectrum, generating colored sparks. The change of the liquid properties gives a chance to control the live time of light sources. In particular, live time of laser-induced images containing bubbles is increases with increasing the liquid viscosity and decreasing the liquid fluidity.

To create laser-induced images of special color characteristics is possible by using special vessel containing the liquid. For this purpose, a vessel containing the liquid, inside of which a laser-induced image is created, is covered by the coating of special light filtering properties. Of course, the cover should be transparent for the used laser radiation but it has different transparent characteristics for other waves. As a result, a laser induced image created by sparks or illuminated bubbles is looked like color image, the hue of which is determined by the cover characteristics.

One or more embodiments of the invention comprise a method for the generation of the breakdown sparks and bubbles inside liquids accompanied by decreased shock waves, comprising:
using the liquids or their solutions which are transparent for used laser radiation and which have low breakdown threshold;
using a vessel containing the liquid, the cover of which is transparent for the used laser radiation and which creates desirable color of a laser-induced image;
generation of laser radiation with parameters providing creation of breakdown sparks and bubbles with decreasing shock waves;
controlling properties of laser radiation for controlling brightness and sizes of sparks and bubbles inside liquids;
creating local liquid areas at which energy density increasing the breakdown threshold corresponding to the liquid.

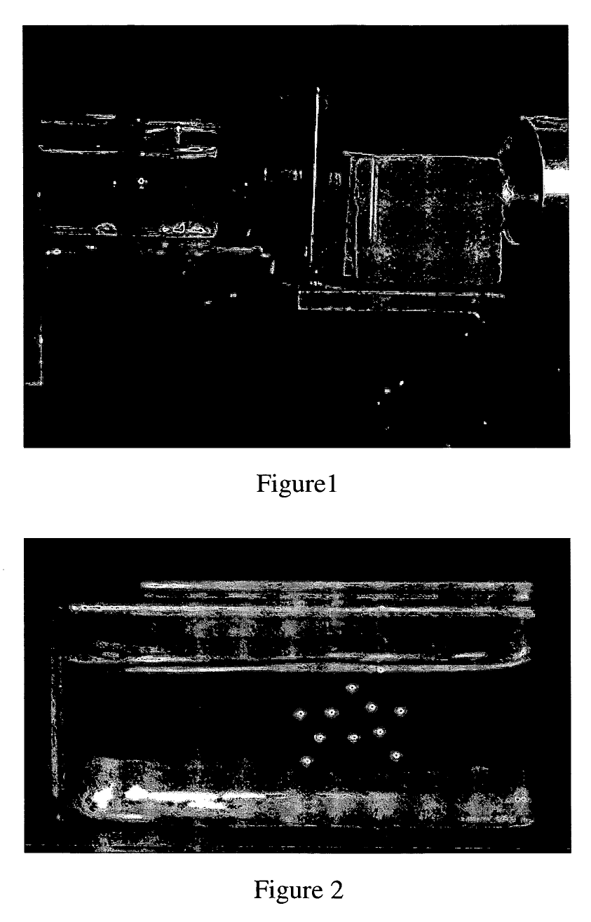

FIG. 1 shows a photo of a breakdown spark produced inside water by Nd YAG laser radiation focused by lens with short focal length (35 mm). FIG. 2 shows a photo of a simple laser-induced image corresponding to an elementary arrangement of the breakdown sparks produced inside water. The image was produced by a method, comprising:
generation of laser radiation providing breakdowns inside the used transparent liquid;
creation of local liquid areas at which the sparks and bubbles are generated by the laser-induced breakdowns;
creation of an arrangement of sparks and bubbles which reproduce the given image;
control of the laser radiation properties for generating sparks and bubble reproducing the laser-induced images of demanded quality.

As it was mentioned above, the laser-induced images inside liquid are not stationary in time: the life time of a laser-induced image containing bubbles is determined by properties of used liquid; the life time of a laser-induced image containing sparks is determined by living time of hot breakdown plasma. The fact of the short life time of the laser-induced images inside liquids permits to produce the motion laser-induced images containing laser-induced bubbles or sparks. Such 2D and 3D motion laser-induced image inside liquids produced by a succession of the small light sources arrangements which replace one another in accordance with the life time of these sources (bubbles or sparks) and in accordance with human eye inertia. The succession of the small light sources arrangements is created inside liquid so that the light sources of the next arrangement are generated after the disappearance of the previous light sources.

One or more embodiments of the invention comprise a method for producing the motion laser-induced images inside liquids, which includes the following steps:

Step 1: generation of the image sequence creating the illusion of motion; transformation of each image of said sequence into arrangement of small light sources, which are produced inside liquid by the laser-induced breakdown.

Step 2: determination of the light parameters of the said small sources needed for the reproduction of space resolution and gray shades of the given image.

Step 3: formation of liquid or its solution with low breakdown threshold and needed fluidity.

Step 4: generation of laser radiation with the parameters needed for production of necessary laser-induced bubbles and sparks.

Step 5: creation of predetermined liquid areas at which laser radiation increases breakdown threshold.

Step 6: production of the sequence of the small light sources arrangements for creation of motion laser-induce image inside liquid.

A laser-induced image inside liquid is created as an arrangement of breakdown sparks or bubbles, or their combination. The transformation of an image into an arrangement of the small light sources is produced, so that the number of the sources corresponds to the space image resolution and the brightness combination of the sources reproduces needed gray shades (half toned images). Such arrangement contains information both about location of the sources inside liquid and about brightness of each light source demanded for reproduction of necessary gray shades. The distances between adjacent bubbles are not smaller the minimal distance so that the shock waves of the breakdowns generated new bubbles do not destroy the bubbles which have been already produced.

A laser-induced damage is a track which a breakdown leaves inside a solid transparent material. Tracks which the breakdowns leave inside a transparent liquid are sparks, bubbles and local physical-chemical changes of the liquid. These changes are the result of the high temperature and high radiation of the very hot breakdown plasma. As a result of this, a part of the liquid molecules inside the breakdown areas are changed and a lot of free atoms and electrons are arisen. At the beginning, the arrangement of local physical-chemical changes reproduces the latent laser-induced image but after a time, the local changes flow and then the liquid does not remember of the image shape but remembers the result of the laser-material interaction as the physical-chemical changes. The level of these changes depends on the total laser energy of the radiation generating the laser-induced breakdowns and the number of these breakdowns. Laser radiation of high total laser energy produces substantial physical-chemical changes of the liquid. These changes can be useful for different applications.

One or more embodiments of the invention comprise a method for creating the latent laser-induced images and the physical-chemical changes of the liquid, comprising:
determining the demanded level of physical-chemical changes of the liquid;
determining the number of the breakdowns and the total laser energy necessary for the production of the predetermined level of the physical-chemical changes;
generation of pulsed laser radiation;
creating arrangement of laser-induced breakdowns inside demanded liquid area.

Local changes of physical-chemical characteristics of liquid create a latent laser-induced image which preserves after the visible image disappears.

I claim:

1. A method for creation of laser-induced images inside transparent liquid, comprising:
generation of the laser radiation providing breakdowns inside the used transparent liquid;
creation of the local liquid areas at which the sparks and bubbles are generated by the laser-induced breakdowns;
creation of an arrangement of sparks and bubbles which reproduce the given image;
control of the laser radiation properties for generating the sparks and bubbles reproducing the laser-induced images of the demanded quality.

2. A method in accordance with claim 1 wherein the pulse energy of generated laser radiation increases a breakdown threshold corresponding to the used liquid.

3. A method in accordance with claim 1 wherein the local liquid area where the laser radiation increases the breakdown threshold is created by focusing said laser radiation at this liquid area.

4. A method in accordance with claim 1 wherein the area where laser energy increases the breakdown threshold is created by the intersection of the several laser beams at this area so that the energy of each said beam does not increase the breakdown threshold but total energy inside the intersection area increases the breakdown threshold.

5. A method in accordance with claim 1 wherein a laser-induced image inside a transparent liquid is an arrangement of sparks irradiating the board spectrum light.

6. A method in accordance with claim 1 wherein a laser-induced image inside a transparent liquid is an arrangement of bubbles which are visible by scattering the exterior light.

7. A method in accordance with claim 1 wherein the distances between adjacent breakdowns are not smaller the minimal distance so that the shock waves of the breakdowns generating the new sparks and bubbles do not destroy adjacent sparks and bubbles which have been already created.

8. A method in accordance with claim 1 wherein the high space resolution of laser-induced images inside liquids is produced by generating the breakdowns which are accompanied by the weak shock waves.

9. A method in accordance with claim 8 wherein the weak shock waves accompanying laser-induced breakdown are created by controlling the laser radiation parameters.

10. A method in accordance with claim 9 wherein controlling laser radiation parameters is produced by the control of the temporal shape of laser pulses and the space structure of the laser radiation.

11. A method in accordance with claim 8 wherein decreasing of the destruction action of the breakdown shock waves is produced by the simultaneous creation of several breakdowns centers so that their shocks waves extinguish each other.

12. A method in accordance with claim 8 wherein the weak shock waves are created by using liquids or their solutions of low breakdown threshold.

13. A method in accordance with claim 1 wherein a half toned image is produced by controlling brightness and sizes of sparks and bubbles inside liquids.

14. A method in accordance with claim 13 wherein the sizes and brightness of the breakdown sparks and bubbles inside liquids are controlled by the change of the pulse energy and by the variation of the pulse duration.

15. A method in accordance with claim 13 wherein decreasing sizes of the breakdown sparks inside liquid is provided by increasing the pressure inside reserved vessel containing the said liquid.

16. A method in accordance with claim 1 wherein desirable color of a laser-induced image inside transparent liquid is produced by covering a vessel surface by light filtering cover which is transparent for the used laser radiation and for the light of the desirable spectra.

17. A method for production of motion laser-induced images inside liquids, which includes the following steps:
Step 1: generation of the image sequence creating the illusion of motion; transformation of each image of said sequence into arrangement of small light sources, which are produced inside liquid by the laser-induced breakdown.
Step 2: determination of light parameters of the said small sources demanded for reproduction of the space resolution and gray shades of the given image.
Step 3: formation of liquids or their solutions with low breakdown threshold and needed viscosity and fluidity.
Step 4: generation of laser radiation of the parameters demanded for the production of necessary laser-induced bubbles and sparks.
Step 5: creation of the local areas at which the laser-induced breakdowns are generated.
Step 6: production of the sequence of the small light sources arrangements for the creation of motion laser-induce image inside liquid.

18. A method in accordance with claim 18 wherein a motion laser-induced image is produced by a succession of small light sources arrangements created inside liquid so that the light sources of the next arrangement are generated after the disappearance of the previous light sources.

19. A method for creating the changes of physical-chemical characteristics of the liquid, comprising:
determining the demanded level of physical-chemical changes of the liquid;
determining the number of the breakdowns and the total laser energy necessary for the production of the predetermined level of the physical-chemical changes;
generation of pulsed laser radiation;
creating arrangement of laser-induced breakdowns inside demanded liquid area.

20. A method in accordance with claim 19 wherein a latent images inside liquid is created by generating the local changes of the physical-chemical characteristics of the said liquid.
